(19) United States
(12) Patent Application Publication
(10) Pub. No.: US 2009/0152381 A1
(43) Pub. Date: Jun. 18, 2009

(54) Air-bubble atomizing device

(76) Inventor: Takashige Kikuchi, Kita-ku (JP)

Correspondence Address: WENDEROTH, LIND & PONACK, L.L.P., 1030 15th Street, N.W.,, Suite 400 East, Washington, DC, 20005-1503, US

(21) Appl. No.: 12/314,432

(22) Filed: Dec. 10, 2008

(30) Foreign Application Priority Data
Dec. 13, 2007 (JP) 2007-322623

(51) Int. Cl. C02F 1/00

(52) U.S. Cl. 239/428.5

(57) ABSTRACT

Air bubbles in a liquid is atomized or pulverized into finer air bubbles by obliquely injecting one air bubble liquid containing air bubbles from a primary injection hole into a production cylinder having an upstream end closed and a downstream end opening to form a primary swirling liquid flow and simultaneously injecting another air bubble liquid containing air bubbles from a secondary injection hole into the production cylinder to form a secondary swirling liquid flow so as to bring the secondary swirling liquid flow into collision with the primary swirling liquid flow, consequently to atomize the air bubbles in the air bubble liquid to further fine air bubbles. The air-bubble atomizing device capable of atomizing or pulverizing the air bubbles in the liquid in such a manner is useful for separating lipids contained in waste liquid, performing surplus sludge treatment and other various industrial purposes.

### BACKGROUND OF THE INVENTION

1. Technical Field

This invention relates to an air-bubble atomizing device useful for atomizing air bubbles in liquid into finer size bubbles, for example, in separating lipids contained in waste liquid or performing surplus sludge treatment.

2. Description of the Related Art

Atomized air bubbles called micro-bubbles often to several tens micrometers in diameter are negatively charged, and therefore, easy to adhere to positive charged matter such as dirt. The negatively charged air bubbles move slowly upward in water. With these properties of the air bubbles, the air bubble liquid containing the atomized air microbubbles having these properties has been so far used for drainage treatment, fish and seafood culture, mechanical parts washing and various other industries. An apparatus for producing liquid containing the micro air bubbles is disclosed in the following patent literatures.

Patent Literature 1: Japanese Patent Application Publication No. 2007-144421(A)

Patent Literature 2: Japanese Patent Application Publication No. 2006-116365(A)

Patent Literature 1 proposed by inventors including the inventor of this invention describes an air bubble atomizer for further atomizing atomized air bubbles in a liquid.

Before atomizing the air bubbles in the liquid by the proposed air bubble atomizer, an air bubble liquid is previously produced by mingling air or gas into a liquid by using pressure inspired by a pressure pump and pulverized into fine air bubbles in the liquid by another air bubble atomizer. The fine air bubbles thus pulverized are further pulverized into smaller micro air bubbles by the proposed air bubble atomizer of Patent Literature 1.

The proposed air bubble atomizer comprises a partition wall having liquid inflow ports on the upstream side of a liquid feeding direction, an outer cylinder opening to the downstream side of the liquid feeding direction, a shaft member formed coaxially in the outer cylinder and having a large diameter part extending along a specified range in the liquid feeding direction and a small diameter part tapering from the upstream side to the downstream side of the liquid feeding direction, and a bubble liquid passage formed between the outer cylinder and the shaft member.

Atomization of the air bubble in the air bubble liquid is carried out while flowing the air bubble liquid forcibly fed by a pressure pump from liquid inflow ports through the inside of the outer cylinder and the bubble liquid passage. At that time, the air bubble liquid is introduced into the inside of the outer cylinder from the liquid inflow ports as the pressure of the air bubble liquid is increased by means of the partition wall, and then, forced to pass through the bubble liquid passage widening from the upstream side toward the downstream side of the liquid feeding direction to change the pressure of the air bubble liquid, consequently to atomize the air bubbles in the air bubble liquid to further fine air bubbles.

Patent Literature 2 describes a fine air-bubble producer for atomizing air bubbles contained in an air bubble liquid to finer air bubbles by swirling the liquid. The fine air-bubble producer of this literature comprises a side-opened cylinder having air introducing holes in a closed side wall and a pressurized liquid introducing hole opened tangentially in a part of the circumferential wall of the cylinder.

The conventional fine air-bubble producer produces the swirling liquid flow in the cylinder by forcibly feeding pressurized liquid from a liquid inlet into the cylinder to cause negative pressure adjacent to the central axis of the cylinder, and further produces a narrow swirling air vortex by allowing air introduced from the liquid inlet into the cylinder by the negative pressure to pass along the central axis of the cylinder, which has the lowest pressure.

The swirling liquid flow flowing from the liquid inlet toward the open side of the cylinder is formed within the cylinder to impart a centrifugal force on the liquid due to difference in specific gravity between air and liquid and provide centripetal force for the air. Consequently, while spraying the air in a vapor-liquid separated state on the open side, the swirling liquid flow weakens exponentially due to the surrounding static liquid at rest resulting in causing a swirling velocity difference to part the swirling air vortex by the swirling velocity difference. As a result, a massive amount of air microbubbles are produced and discharged from the open side of the cylinder.

However, the air bubble atomizer described in the aforementioned Patent Literature 1 is inevitably complex in structure because it necessitates a mechanism for inducing the change of pressure.

The fine air-bubble producer of Patent Literature 2 has a function of subdividing air bubbles by immixing air bubbles into the liquid, but it is impossible to atomize air bubbles in an air bubble liquid into finer size air bubbles.

### SUMMARY OF THE INVENTION

This invention is made to eliminate the drawbacks suffered by the conventional devices for producing air-microbubble liquid as described above and has an object to provide a simple and high-performance air-bubble atomizing device which is capable of easily producing an air-microbubble liquid containing finer air bubbles by bringing air bubbles into collision with one another or with the liquid to atomize the bubbles into further fine air bubbles in the liquid.

To attain the object described above according to the present invention, there is provided an air-bubble atomizing device for atomizing air bubbles contained in an air bubble liquid produced by mingling air bubbles with a liquid, which comprises a production cylinder having an upstream end closed, a downstream end opening to form a release port and a cylindrical wall with a primary injection hole for obliquely injecting the air bubble liquid along a supposed line parallel to a supposed tangent line of an inner peripheral surface of the cylindrical wall and a secondary injection hole for injecting the air bubble liquid with displacement so as to bring the injected air bubble liquid close to the axial center of the cylinder with respect to the injection direction of the air bubble liquid injected from the primary injection hole, wherein a primary swirling liquid flow is produced by the air bubble liquid injected from the primary injection hole in the production cylinder while tangling and mingling a secondary swirling liquid flow formed by the air bubble liquid injected from the secondary injection hole with the primary swirling liquid flow, thereby to produce air microbubbles in the liquid.

According to the device of the invention, the flow of the air bubble liquid swirling within the production cylinder, namely, the primary swirling liquid flow, can be formed by injecting the air bubble liquid from the primary injection hole into the cylinder by pressure so as to lead the liquid flow along the inner peripheral surface of the cylinder. Simultaneously with the formation of the primary swirling liquid flow, the secondary swirling liquid flow aside from the aforesaid primary flow is also formed by injecting the air bubble liquid to bring the injected air bubble liquid close to the axial center of the cylinder from the secondary injection hole, thus to bring the secondary swirling liquid flow into collision with the primary swirling liquid flow so as to disrupt the primary swirling liquid flow within the cylinder. As a result, the air bubble liquid collides with the air bubbles in the liquid, or the air bubbles collide with one another in the liquid, so that the air bubbles can be pulverized into finer air bubbles, to atomize the air bubbles in the liquid.

According to another aspect, the invention provides an air-bubble atomizing device in which the primary injection hole is placed on the upstream side from the secondary swirling liquid flow.

According to this invention, the orientation of the primary injection hole placed on the upstream side causes the secondary swirling liquid flow spouted from the secondary injection hole to collide with the primary swirling liquid flow regularly flowing along the inner peripheral surface of the cylinder, so that the air bubbles in the liquid can be steadily pulverized into finer air bubbles.

According to still another aspect, the invention provides an air-bubble atomizing device in which the primary injection hole is obliquely directed toward the inner peripheral surface in the circumferential direction of the production cylinder and opens in the direction orthogonal to the axial direction of the cylinder.

According to this invention, the primary swirling liquid flow generated within the production cylinder brings about an effect of inhibiting its own outflow to the release port, thus to steadily intermingle with the secondary swirling liquid flow.

According to yet another aspect, the invention provides an air-bubble atomizing device in which the primary injection hole is obliquely directed toward the inner peripheral surface along the circumferential direction of the production cylinder and opens obliquely to the upstream side.

According to this invention, the air bubble liquid can be spouted from the primary injection hole toward the upstream side, thus to create a retention state of the primary injection hole in the production cylinder. Consequently, intermingling of the secondary swirling liquid flow with the primary swirling liquid flow produced subsequently is fulfilled, so that it can be expected that the air bubbles in the liquid collide steadily with one another in conjunction with intermingling of the primary swirling liquid flow with the secondary swirling liquid flow.

According to still more aspect, the invention provides an air-bubble atomizing device in which the production cylinder has a cylindrical cross-section.

According to this invention, the production cylinder having the cylindrical cross-section can stabilize the primary swirling liquid flow.

According to still more aspect, the invention provides an air-bubble atomizing device in which the production cylinder has a non-cylindrical cross-section.

According to this invention, the production cylinder having the non-cylindrical cross-section cause the primary and secondary swirling liquid flows to collide with the corner portions of the inner peripheral surface of the cylinder to bring about diversions of the liquid, so that intermingling and collision of the primary swirling liquid flow with the secondary swirling liquid flow and collision of diversions with each other can be expected.

According to still more aspect, the invention provides an air-bubble atomizing device in which the primary and secondary injection holes are directed from the upstream side to the downstream side of the production cylinder and arranged alternately at a suitable interval.

According to this invention, the multiple primary and secondary injection holes arranged alternately can bring the plural swirling liquid flows spouted from the respective injection holes into collision with one another.

According to a further aspect the invention provides an air-bubble atomizing device in which the primary and secondary injection holes are formed separately in the circumferential direction of the production cylinder.

According to this invention, the air bubble liquids can be injected into the production cylinder from various directions.

According to a still further aspect, the invention provides an air-bubble atomizing device further comprises a lead stem which is disposed within the production cylinder along the axial center of the cylinder and has a cylindrical small diameter part and a swelling part continuous from the small diameter part on the downstream side of the small diameter part.

According to this invention, the primary swirling liquid flow can be brought into collision with the secondary swirling liquid flow as it stably swirls around the small diameter part.

According to a still further aspect the invention provides an air-bubble atomizing device in which the lead stem is formed in a substantially conical shape having the swelling part gradually tapering toward the downstream side.

According to this invention, the primary swirling liquid flow can be brought into collision with the secondary swirling liquid flow as it stably swirls around the small diameter part, and the swirling of the liquid flow can be further stabilized by the swelling part.

As is described above, according to the air-bubble atomizing device of the invention, the primary and secondary swirling liquid flows formed by flowing the air bubble liquids in different directions in the production cylinder are tangled and mingled with each other to cause the air bubble liquid to collide with the air bubbles in the air bubble liquid or the air bubbles to collide with one another in the liquid, so that an intended air-microbubble liquid containing a number of fine air bubbles can easily be produced by pulverizing the air bubbles preexisting in the liquid.

The aforementioned and other objects and advantages of the invention will become more apparent from the following detailed description of particular embodiments of the invention taken in conjunction with the accompanying drawings.

### BRIEF DESCRIPTION OF THE DRAWINGS

FIG. 1 is a perspective view showing an air-bubble atomizing device according to a first embodiment of the present invention.

FIGS. 2A and 2B are enlarged sectional views taken along line IIa-IIa and line IIb-IIb in FIG. 1, both showing the flow of an air bubble liquid.

FIG. 3 is a sectional views taken along line III-III in FIG. 2.

FIG. 4 is a sectional views taken along line III-III in FIG. 2, showing the air-bubble atomizing device according to a second embodiment of the invention.

FIG. 5 is a perspective view showing the air-bubble atomizing device according to a third embodiment of the invention.

FIGS. 6A and 6B are enlarged sectional views taken along line VIa-VIa and line VIb-VIb in FIG. 5.

FIG. 7 is a sectional views taken along line III-III in FIG. 2, showing the air-bubble atomizing device according to a fourth embodiment of the invention.

### DETAILED DESCRIPTION OF THE PREFERRED EMBODIMENTS OF THE INVENTION

The preferred embodiments of the present invention with respect to an air-bubble atomizing device will be described hereinafter in detail with reference to the accompanying drawings.

### Embodiment 1

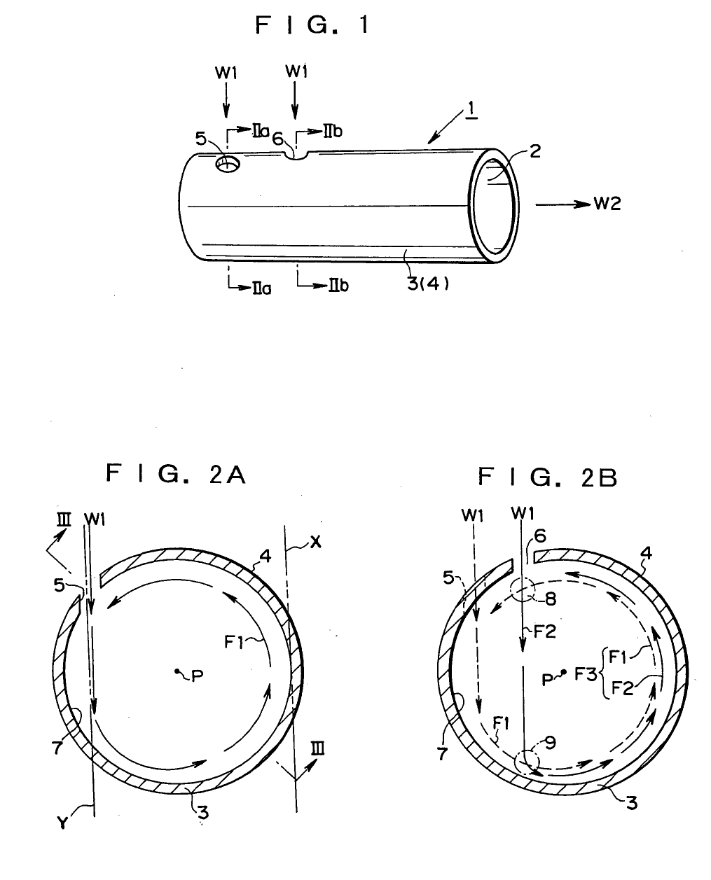

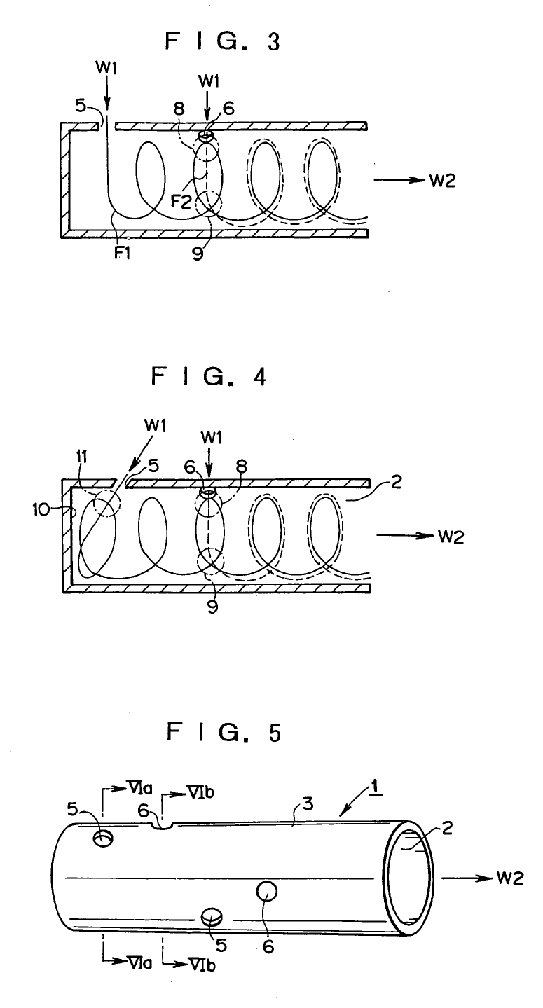

FIG. 1 is a perspective view showing the air-bubble atomizing device 1 according to the first embodiment of the invention, FIGS. 2A and 2B are enlarged sectional views taken along line IIa-IIa and line IIb-IIb in FIG. 1, both showing the flow of an air bubble liquid, and FIG. 3 is a sectional views taken along line III-III in FIG. 2.

The air-bubble atomizing device 1 in the first embodiment of the invention serves to atomize or pulverize air bubbles contained in a air bubble liquid W1 produced and forcibly fed by an air bubble liquid producing device (not shown in the drawings) into finer air bubbles. An air-microbubble liquid W2 containing air microbubbles atomized or pulverized by the air-bubble atomizing device 1 is fed to a not-shown liquid to be treated such as waste fluid containing lipids.

As shown in FIG. 1 and FIG. 3, the air-bubble atomizing device 1 comprises a production cylinder 3 having an upstream end (left part in the drawings) closed, a downstream end (right part in the drawings) opening to form a release port 2 and a cylindrical wall 4 with a primary injection hole 5 and secondary injection hole 6 for injecting the forcibly fed air bubble liquids W1 into the production cylinder 3 through the cylindrical wall 4.

The primary injection hole 5 is bored in the cylindrical wall 4 of the production cylinder 3 on the upstream side of the secondary injection hole 6. As shown in FIG. 2A, the primary injection hole 5 is opens in the direction orthogonal to the axial direction P of the cylinder 3 along a supposed line Y parallel to a supposed tangent line X of the inner peripheral surface 7 of the production cylinder 3 so as to obliquely inject the air bubble liquid W1 toward the inner peripheral surface 7. That is, the primary injection hole 5 is formed so as to inject the air bubble liquid W1 toward the inner peripheral surface 7 of the cylinder 3 in a direction oblique to the circumferential direction of the production cylinder 3.

The air bubble liquid W1 forcibly fed from the outside of the production cylinder 3 is introduced into the production cylinder 3 through the primary injection hole 5 and, upon reaching the inner peripheral surface 7 of the cylinder 3, advances along the inner peripheral surface 7 of the cylinder 3 while swiveling, thus to produce a primary swirling liquid flow F1.

The primary swirling liquid flow F1 flows from the upstream side to the downward side toward the release port 2 while swiveling within the cylinder.

The secondary injection hole 6 is formed in the cylindrical wall 4 of the cylinder 3 on the downstream side of the primary injection hole 5. As shown in FIG. 2B, the secondary injection hole 6 is formed orthogonally to the direction of the axial center P of the cylinder 3, so that the air bubble liquid W1 is injected with displacement so as to approach the axial center P of the cylinder 3 with respect to the direction in which the air bubble liquid is injected from the primary injection hole 5.

Similarly to the primary swirling liquid flow F1, the air bubble liquid W1 forcibly fed from the outside of the production cylinder 3 is introduced into the production cylinder 3 through the secondary injection hole 6 and, upon reaching the inner peripheral surface 7 of the cylinder 3, advances along the inner peripheral surface 7 of the cylinder 3 while swiveling, thus to produce a secondary swirling liquid flow F2. At this time, the secondary swirling liquid flow F2 thus generated by injecting the air bubble liquid W1 into the cylinder collides with the primary swirling liquid flow F1 flowing in the cylinder 3 at a first crossing point 8 near the secondary injection hole 6. Thus, the secondary swirling liquid flow F2 collides with the primary swirling liquid flow F1 so as to disrupt the primary swirling liquid flow F1 within the cylinder, thereby to cause the air bubble liquid W1 to collide with the air bubbles in the liquid W1 or the air bubbles in the liquid W1 to collide with one another. As a result the air bubbles in the air bubble liquid W1 are pulverized or atomized to finer air bubbles in the liquid.

After intermingling the primary and secondary swirling liquid flows F1 and F2 with each other at the first crossing point 8, the secondary swirling liquid flow F2 keeps advancing straight and collides with the primary swirling liquid flow F1 at a second crossing point 9 right before reaching the inner peripheral surface 7 of the production cylinder 3. At this time, the secondary swirling liquid flow F2 collides with the primary swirling liquid flow F1 so as to disrupt the primary swirling liquid flow within the cylinder. As a result, the air bubble liquid W1 collides with the air bubbles in the liquid W1, or the air bubbles collide with one another in the liquid W1, so that the air bubbles can be pulverized into finer air bubbles, to atomize the air bubbles in the liquid W1.

As stated above, the secondary swirling liquid flow F2 collides with the primary swirling liquid flow F1 at the first crossing point 8 and the second crossing point 9 to produce the air-microbubble liquid W2 containing air microbubbles pulverized by crossing the primary and secondary swirling liquid flows F1 and F2, and then, upon reaching the inner peripheral surface 7 of the cylinder 3, the secondary swirling liquid flow F2 reaches the inner peripheral surface 7 of the cylinder 3 and flows along the inner peripheral surface 7 while swiveling and mingling with the primary swirling liquid flow F1, thus to produce a mixed swirling liquid flow F3 derived from the secondary swirling liquid flow F2. The mixed swirling liquid flow F3 flows toward the downstream side while swiveling within the cylinder and is discharged out of the cylinder through the release port 2.

As stated above, according to the air-bubble atomizing device 1 of the first embodiment of the invention, the primary and secondary swirling liquid flows F1 and F2 formed by flowing the air bubble liquids W1 in different directions in the production cylinder 3 are tangled and mingled with each other to cause the air bubble liquid W1 to collide with the air bubbles in the air bubble liquid or the air bubbles to collide with one another in the liquid, so that an air-microbubble liquid W2 containing a number of fine air bubbles can easily be produced by pulverizing the air bubbles preexisting in the liquid and sent out to a not-shown liquid to be treated such as waste fluid containing lipids.

### Embodiment 2

Next, the second embodiment of the invention will be described with reference to FIG. 4 which is a sectional views taken along line III-III in FIG. 2. In the drawings, the reference numerals which have equivalents in the drawings of the embodiment mentioned above denote identical or equal component elements. The description of these component elements is omitted below to avoid repetition.

Although the air-bubble atomizing device of Embodiment 1 described above has the primary and secondary injection holes 5 and 6 formed orthogonally to the axial direction of the production cylinder 3, the primary injection hole 5 may be formed obliquely to be direct to the side of the closed end (upstream side), as shown in FIG. 4.

Where the primary injection hole 5 is formed obliquely to be directed to the side of the closed end, the primary swirling liquid flow F 1 flows once to the side of the closed end of the cylinder, and upon reaching the wall 10, it is sent toward the side of the released port 2 on the downstream side. Thus, the primary swirling liquid flow F1 returning after reaching the wall 10 again intersects and collides with newly introduced swirling liquid flow F1 injected from the primary injection hole 5 at a third crossing point 11 near the primary injection hole 5.

The intersect of the primary swirling liquid flows F1 with each other cause the air bubbles in the air bubble liquid W1 to be once pulverized and then sent toward the release port 2 as it swirls along the inner peripheral surface 7 of the cylinder 3.

Thereafter, the primary and secondary swirling liquid flows F1 and F2 collide with each other at the first crossing point 8 near the secondary injection hole 6 and at the second crossing point 9, consequently to produce the air-microbubble liquid W2 containing air microbubbles. Then, the primary and secondary swirling liquid flows F1 and F2 move toward the downstream side as it swivels along the inner peripheral surface 7 and mingling with each other. Resultantly, the mixed swirling liquid flow F3 derived from the air-microbubble liquid W2 is sent to the outside of the cylinder through the release port 2.

### Embodiment 3

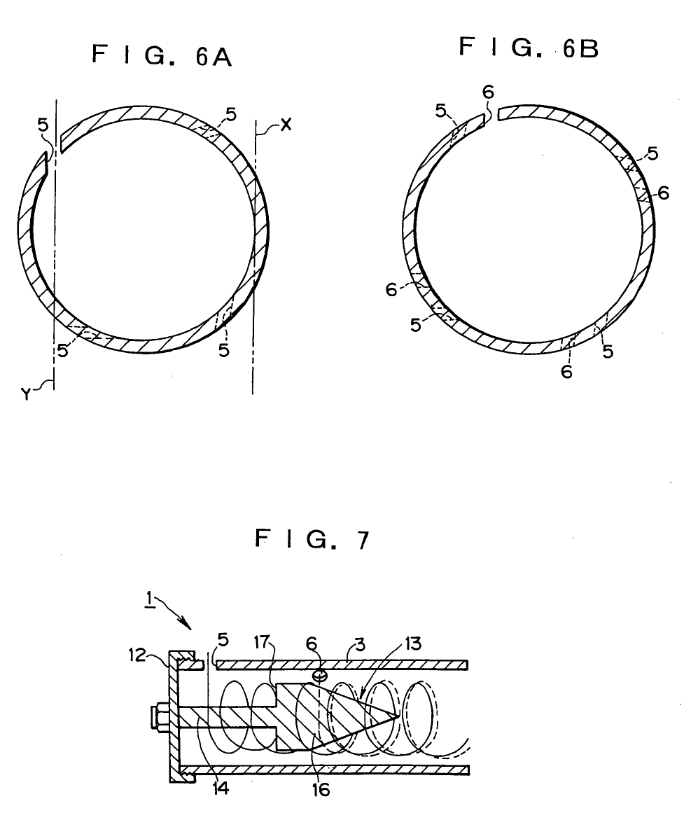

Next the third embodiment of the invention will be described with reference to FIG. 5 which is a perspective view of the air-bubble atomizing device of Embodiment 3 and FIGS. 6A and 6B which are enlarged sectional views taken along line VIa-VIa and line VIb-VIb in FIG. 5. Most elements of the device depicted in this embodiment have the same function as their counterparts in the foregoing embodiments. These elements are assigned by the same reference numerals as those in the foregoing embodiments and will not be described further here.

Although one primary injection hole 5 and one secondary injection hole 6 are used respectively in the foregoing embodiments, the air-bubble atomizing device of this embodiment may have one or more primary injection holes 5 and one or more secondary injection hole 6 as long as one of the primary injection holes 5 is formed on the uppermost stream side. That is, a plurality of injection holes may be arranged separately in the circumferential direction of the production cylinder as shown in FIGS. 5, 6A and 6B.

Even in this case, similarly to Embodiments 1 and 2 as described above, the primary injection hole 5 is opens in the direction orthogonal to the axial direction P of the cylinder 3 along a supposed line Y parallel to a supposed tangent line X of the inner peripheral surface 7 of the production cylinder 3 so as to obliquely inject the air bubble liquid W1 toward the inner peripheral surface 7. That is, the primary injection hole 5 is formed so as to inject the air bubble liquid W1 toward the inner peripheral surface 7 of the cylinder 3 in a direction oblique to the circumferential direction of the production cylinder 3. The secondary injection hole 6 is formed with displacement so as to approach the axial center P of the cylinder 3 with respect to the direction in which the air bubble liquid is injected from the primary injection hole 5 to inject the air bubble liquid W1.

As just described, where the multiple primary injection holes 5 and multiple secondary injection holes 6 are used, the resultantly formed primary swirling liquid flows F1 and secondary swirling liquid flows F2 are tangled and mingled several times, consequently to produce further fine air bubbles in the air bubble liquid W1.

Meanwhile, one of the primary injection holes 5 has only to be formed on the uppermost stream side of the production cylinder 3, and other primary injection holes 5 may be arranged arbitrarily. Also, this embodiment provides an example of arranging the primary and secondary injection holes alternately, but a plurality of secondary injection holes may be formed successively.

### Embodiment 4

Next, the forth embodiment of the invention will be described with reference to FIG. 7 which is a sectional views taken along line III-III in FIG. 2. Most elements of the device depicted in this embodiment have the same function as their counterparts in the foregoing embodiments. These elements are assigned by the same reference numerals as those in the foregoing embodiments and will not be described further here.

The production cylinder 3 in this embodiment is closed with a lid 12 in place of the wall 10 in the foregoing embodiments. The lid 12 is provided integrally with a lead stem 13 so as to position the lead stem 13 along the center of axle of the production cylinder 3.

The lead stem 13 has a small diameter part 14 having a constant outer diameter over a prescribed length along the center of axle of the cylinder and a conical-shaped swelling part 16 continuous from the small diameter part 14 and gradually tapering toward the downstream side.

Where the stem 13 is disposed within the production cylinder 3, it is required to form the primary injection hole 5 around the small diameter part 14 (the upper side of the small diameter part 14 in this embodiment) and the secondary injection hole 6 around the swelling part 16 (the upper side of the small diameter part 14 in this embodiment).

The air bubble liquid W1 injected from the primary injection hole 5 into the inside of the production cylinder 3 swivels along the inner peripheral surface 7 of the cylinder 3 to produce the primary swirling liquid flow F1. At this time, as the air bubble liquid W1 swivels around the small diameter part 14, it can swivel smoothly and stably without being interrupted in the vicinity of the center of axle of the cylinder.

The primary swirling liquid flow F1 revolves around the small diameter part 14, and then, flows in the downstream direction while colliding with the side surface 17 of the swelling part 16 as it revolves around the swelling part 16. Thereafter, the secondary swirling liquid flow F2 produced by causing the air bubble liquid W1 injected from the secondary injection hole 6 to swirl around the swelling part 16 collides with the primary swirling liquid flow F1 at an area near the secondary injection hole 6 so that the air bubbles in the liquid W1 are pulverized by bringing the air bubble liquid W1 in collision with the air bubbles in the air bubble liquid W1 or the air bubbles in the air bubble liquid W1 in collision with one another and further pulverized by change of pressure around the swelling part 16, to cause the air-microbubble liquid W2 to be produced and discharged from the release port 2.

According to this embodiment of the invention, the primary swirling liquid flow F1 can swirl around the small diameter part 14 by the stem 13 disposed within the production cylinder 3, thus to permit the primary swirling liquid flow F1 to swivel smoothly and stably.

Besides, the primary and secondary swirling liquid flows F1 and F2 collide with each other near the secondary injection hole 6 by the secondary injection hole 6 formed around the swelling part 16, thereby to effectively pulverize the air bubbles in the liquid.

Although the production cylinder 3 having a cylindrical cross section is applied to one example of the invention as described above, the cross-sectional shape of the production cylinder is not specifically limited. That is, the production cylinder 3 may have a cross section shaped in a square, quadrangle or any other polygonal shape, thus to cause the primary and secondary swirling liquid flows to collide with the corner portions of the inner peripheral surface of the cylinder to bring about diversions of the liquid, so that intermingling and collision of the primary swirling liquid flow with the secondary swirling liquid flow and collision of diversions with each other can be expected.

Further, since the flow volume and flow velocity of the primary and secondary swirling liquid flow F1 and F2 can arbitrarily vary with the fluid pressure of the forcibly fed air bubble liquid W1 and the diameter and number of the respective primary and secondary injection holes 5 and 6, they can be designed unrestrainedly.

While the invention has been particularly shown and described with reference to certain preferred embodiments, it will be understood by those skilled in the art that various alterations and modifications in form and detail may be made therein. Accordingly, it is intended that the following claims cover all such alterations and modifications as may fall within the true spirit and scope of the invention.

What is claimed is:

1. An air-bubble atomizing device for atomizing air bubbles contained in an air bubble liquid produced by mingling air bubbles with a liquid, comprising a production cylinder having an upstream end closed, a downstream end opening to form a release port and a cylindrical wall with a primary injection hole for obliquely injecting the air bubble liquid along a supposed line parallel to a supposed tangent line of an inner peripheral surface of said cylindrical wall and a secondary injection hole for injecting said air bubble liquid with displacement so as to bring the injected air bubble liquid close to the axial center of said cylinder with respect to the injection direction of said air bubble liquid injected from said primary injection hole, wherein a primary swirling liquid flow is produced by said air bubble liquid injected from said primary injection hole in said production cylinder while tangling and mingling a secondary swirling liquid flow formed by said air bubble liquid injected from said secondary injection hole with said primary swirling liquid flow, thereby to produce air microbubbles in said liquid.

2. The air-bubble atomizing device according to claim 1, wherein said primary injection hole is placed on an upstream side from said secondary swirling liquid flow.

3. The air-bubble atomizing device according to claim 1, wherein said primary injection hole is obliquely directed toward the inner peripheral surface in the circumferential direction of said production cylinder and opens in the direction orthogonal to the axial direction of said cylinder.

4. The air-bubble atomizing device according to claim 2, wherein said primary injection hole is obliquely directed toward the inner peripheral surface in the circumferential direction of said production cylinder and opens in the direction orthogonal to the axial direction of said cylinder.

5. The air-bubble atomizing device according to claim 1, wherein said primary injection hole is obliquely directed toward the inner peripheral surface along the circumferential direction of said production cylinder and opens obliquely to the upstream side.

6. The air-bubble atomizing device according to claim 2, wherein said primary injection hole is obliquely directed toward the inner peripheral surface along the circumferential direction of said production cylinder and opens obliquely to the upstream side.

7. The air-bubble atomizing device according to claim 1, wherein said production cylinder has a cylindrical cross-section.

8. The air-bubble atomizing device according to claim 2, wherein said production cylinder has a cylindrical cross-section.

9. The air-bubble atomizing device according to claim 3, wherein said production cylinder has a cylindrical cross-section.

10. The air-bubble atomizing device according to claim 4, wherein said production cylinder has a cylindrical cross-section.

11. The air-bubble atomizing device according to claim 5, wherein said production cylinder has a cylindrical cross-section.

12. The air-bubble atomizing device according to claim 6, wherein said production cylinder has a cylindrical cross-section.

13. The air-bubble atomizing device according to claim 1, wherein said production cylinder has a non-cylindrical cross-section.

14. The air-bubble atomizing device according to claim 2, wherein said production cylinder has a non-cylindrical cross-section.

15. The air-bubble atomizing device according to claim 3, wherein said production cylinder has a non-cylindrical cross-section.

16. The air-bubble atomizing device according to claim 4, wherein said production cylinder has a non-cylindrical cross-section.

17. The air-bubble atomizing device according to claim 5, wherein said production cylinder has a non-cylindrical cross-section.

18. The air-bubble atomizing device according to claim 6, wherein said production cylinder has a non-cylindrical cross-section.

19. The air-bubble atomizing device according to claim 1, wherein said primary and secondary injection holes are directed from the upstream side to the downstream side of said production cylinder and arranged alternately at a suitable interval.

20. The air-bubble atomizing device according to claim 2, wherein said primary and secondary injection holes are directed from the upstream side to the downstream side of said production cylinder and arranged alternately at a suitable interval.

21. The air-bubble atomizing device according to claim 3, wherein said primary and secondary injection holes are directed from the upstream side to the downstream side of said production cylinder and arranged alternately at a suitable interval.

22. The air-bubble atomizing device according to claim 4, wherein said primary and secondary injection holes are directed from the upstream side to the downstream side of said production cylinder and arranged alternately at a suitable interval.

23. The air-bubble atomizing device according to claim 5, wherein said primary and secondary injection holes are directed from the upstream side to the downstream side of said production cylinder and arranged alternately at a suitable interval.

24. The air-bubble atomizing device according to claim 6, wherein said primary and secondary injection holes are directed from the upstream side to the downstream side of said production cylinder and arranged alternately at a suitable interval.

25. The air-bubble atomizing device according to claim 19, wherein said primary and secondary injection holes are formed separately in the circumferential direction of said production cylinder.

26. The air-bubble atomizing device according to claim 20, wherein said primary and secondary injection holes are formed separately in the circumferential direction of said production cylinder.

27. The air-bubble atomizing device according to claim 21, wherein said primary and secondary injection holes are formed separately in the circumferential direction of said production cylinder.

28. The air-bubble atomizing device according to claim 22, wherein said primary and secondary injection holes are formed separately in the circumferential direction of said production cylinder.

29. The air-bubble atomizing device according to claim 23, wherein said primary and secondary injection holes are formed separately in the circumferential direction of said production cylinder.

30. The air-bubble atomizing device according to claim 24, wherein said primary and secondary injection holes are formed separately in the circumferential direction of said production cylinder.

31. The air-bubble atomizing device according to claim 1, further comprising a lead stem which is disposed within said production cylinder along the axial center of said cylinder and has a cylindrical small diameter part and a swelling part continuous from the small diameter part on the downstream side of the small diameter part.

32. The air-bubble atomizing device according to claim 2, further comprising a lead stem which is disposed within said production cylinder along the axial center of said cylinder and has a cylindrical small diameter part and a swelling part continuous from the small diameter part on the downstream side of the small diameter part.

33. The air-bubble atomizing device according to claim 3, further comprising a lead stem which is disposed within said production cylinder along the axial center of said cylinder and has a cylindrical small diameter part and a swelling part continuous from the small diameter part on the downstream side of the small diameter part.

34. The air-bubble atomizing device according to claim 4, further comprising a lead stem which is disposed within said production cylinder along the axial center of said cylinder and has a cylindrical small diameter part and a swelling part continuous from the small diameter part on the downstream side of the small diameter part.

35. The air-bubble atomizing device according to claim 5, further comprising a lead stem which is disposed within said production cylinder along the axial center of said cylinder and has a cylindrical small diameter part and a swelling part continuous from the small diameter part on the downstream side of the small diameter part.

36. The air-bubble atomizing device according to claim 6, further comprising a lead stem which is disposed within said production cylinder along the axial center of said cylinder and has a cylindrical small diameter part and a swelling part continuous from the small diameter part on the downstream side of the small diameter part.

37. The air-bubble atomizing device according to claim 31, wherein said lead stem is formed in a substantially conical shape having said swelling part gradually tapering toward the downstream side.

38. The air-bubble atomizing device according to claim 32, wherein said lead stem is formed in a substantially conical shape having said swelling part gradually tapering toward the downstream side.

39. The air-bubble atomizing device according to claim 33, wherein said lead stem is formed in a substantially conical shape having said swelling part gradually tapering toward the downstream side.

40. The air-bubble atomizing device according to claim 34, wherein said lead stem is formed in a substantially conical shape having said swelling part gradually tapering toward the downstream side.

41. The air-bubble atomizing device according to claim 35, wherein said lead stem is formed in a substantially conical shape having said swelling part gradually tapering toward the downstream side.

42. The air-bubble atomizing device according to claim 36, wherein said lead stem is formed in a substantially conical shape having said swelling part gradually tapering toward the downstream side.
